(19) United States
(12) Patent Application Publication
(10) Pub. No.: US 2026/0055823 A1
(43) Pub. Date: Feb. 26, 2026

(54) ELECTROMAGNETIC VALVE

(71) Applicant: FUJIKOKI CORPORATION, Setagaya-ku, Tokyo (JP)

(72) Inventors: Hiroshi KAINUMA, Setagaya-ku, Tokyo (JP); Kazuhiro MIYAMOTO, Setagaya-ku, Tokyo (JP)

(21) Appl. No.: 19/115,896

(22) PCT Filed: Nov. 22, 2023
(86) PCT No.: PCT/JP2023/042065

§ 371 Date: Mar. 27, 2025

(30) Foreign Application Priority Data
Jan. 20, 2023 (JP) 2023-007640

(51) Int. Cl. F16K 47/02; F16K 27/02; F16K 31/06

(52) U.S. Cl. CPC F16K 47/02; F16K 27/029; F16K 31/0655; F16K 31/0675

(57) ABSTRACT

An electromagnetic valve includes: a solenoid around which a coil is wound; an attractor that is disposed inside the solenoid; a plunger that is attracted to the attractor by energization of the solenoid and is connected to a valve shaft (valve body); a pipe that is provided inside the solenoid and houses the plunger; and a housing that includes a first support disposed to overlap with one end of the solenoid in an axial direction and a second support disposed to overlap with the other end of the solenoid in the axial direction, and that has, in the first support and the second support, a first attachment hole and a second attachment hole into which the pipe is fitted, respectively. The first attachment hole abuts an outer circumference of the pipe on one side in a radial direction thereof.

### TECHNICAL FIELD

The present disclosure relates to an electromagnetic valve.

### BACKGROUND ART

Japanese Patent Application Laid-Open (JP-A) No. 2014-152848 discloses a differential pressure regulating valve-equipped electromagnetic valve used in a heat pump cycle. This electromagnetic valve has a structure in which a main valve seat is opened when a solenoid is not energized, and a moving core is attracted to a fixed core when the solenoid is energized (when turned ON) so that a plunger is lowered and a main valve body closes the main valve seat.

### SUMMARY OF INVENTION

### Technical Problem

Pulse width modulation (PWM) control may be employed to control electromagnetic valves from the viewpoint of power saving and the like. The PWM control is used for controlling power applied to a load by fixing a frequency of a rectangular wave and varying a ratio (duty ratio) of a time when a voltage is high, and is also referred to as duty control.

However, in the case of the PWM control, a valve-closed state is maintained while the solenoid is repeatedly turned ON and OFF at high speed even at the time of ON. Since sound is generated when a moving core is attached to a fixed core, repetition of attachment and detachment of the moving core to and from the fixed core at high speed causes noise and vibration.

An object of the disclosure is to curb generation of noise and vibration in an electromagnetic valve.

### Solution to Problem

An electromagnetic valve according to a first aspect includes: a solenoid around which a coil is wound; an attractor that is disposed inside the solenoid; a plunger that is connected to a valve body and is attracted to the attractor by energization of the solenoid; a pipe that is provided inside the solenoid and accommodates the plunger; and a housing that includes a first support disposed to overlap with one end of the solenoid in an axial direction and a second support disposed to overlap with the other end of the solenoid in the axial direction, and that has, in the first support and the second support, a first attachment hole and a second attachment hole into which the pipe is fitted, respectively, in which the first attachment hole abuts an outer circumference of the pipe on one side in a radial direction thereof.

In this electromagnetic valve, the housing has both the first attachment hole and the second attachment hole into which the pipe accommodating the plunger is fitted. The first attachment hole abuts the outer circumference of the pipe on one side in the radial direction thereof. That is, the pipe is restrained by the housing in the radial direction. Consequently, even if the plunger is attached to or detached from the attractor at high speed when the solenoid is PWM-controlled, vibration of the pipe is curbed.

According to a second aspect of the electromagnetic valve according to the first aspect, the first attachment hole and the second attachment hole have the same diameter, and a center of the first attachment hole and a center of the second attachment hole are shifted in the radial direction of the pipe.

In this electromagnetic valve, since the centers of the first attachment hole and the second attachment hole having the same diameter are shifted from each other in the radial direction of the pipe, the outer circumference of the pipe abuts the first attachment hole on one side in the radial direction when the pipe is fitted into the first attachment hole and the second attachment hole. Such a simple configuration enables vibration of the pipe to be curbed.

According to a third aspect of the electromagnetic valve according to the first or second aspect, the first attachment hole and the second attachment hole have the same diameter.

According to a fourth aspect of the electromagnetic valve according to any one of the first to third aspects, the housing includes a plate-shaped connection portion that connects the first support and the second support, and the first attachment hole abuts the outer circumference of the pipe on one side in a direction parallel to the connection portion.

According to a fifth aspect of the electromagnetic valve according to any one of the first to fourth aspects, the second attachment hole abuts the outer circumference of the pipe on the other side in the radial direction thereof.

Consequently, since the pipe is further restrained by the housing in the radial direction, the vibration of the pipe is further curbed.

### Advantageous Effects of Invention

According to the disclosure, generation of noise and vibration in the electromagnetic valve can be curbed.

### BRIEF DESCRIPTION OF DRAWINGS

FIG. 1 is a cross-sectional view showing an expansion valve including an electromagnetic valve according to the embodiment.

FIG. 2 is an enlarged cross-sectional view showing the electromagnetic valve according to the embodiment.

FIG. 3 is a perspective view showing a configuration of a part of the electromagnetic valve according to the embodiment.

FIG. 4 is a perspective view showing a housing.

FIG. 5 is a plan view showing the housing.

### DESCRIPTION OF EMBODIMENT

Hereinafter, embodiments of the disclosure will be described with reference to the drawings. Components denoted by the same reference numerals in the drawings mean the same or similar components. Redundant descriptions and reference numerals in the embodiments to be described below may be omitted. The drawings used in the following description are all schematic, and dimensional relationships between individual components, ratios between individual components, and the like shown in the drawings are not necessarily the same as actual ones. Dimensional relationships between individual components, ratios between individual components, and the like are also not necessarily the same among the plurality of drawings.

### Electromagnetic Valve

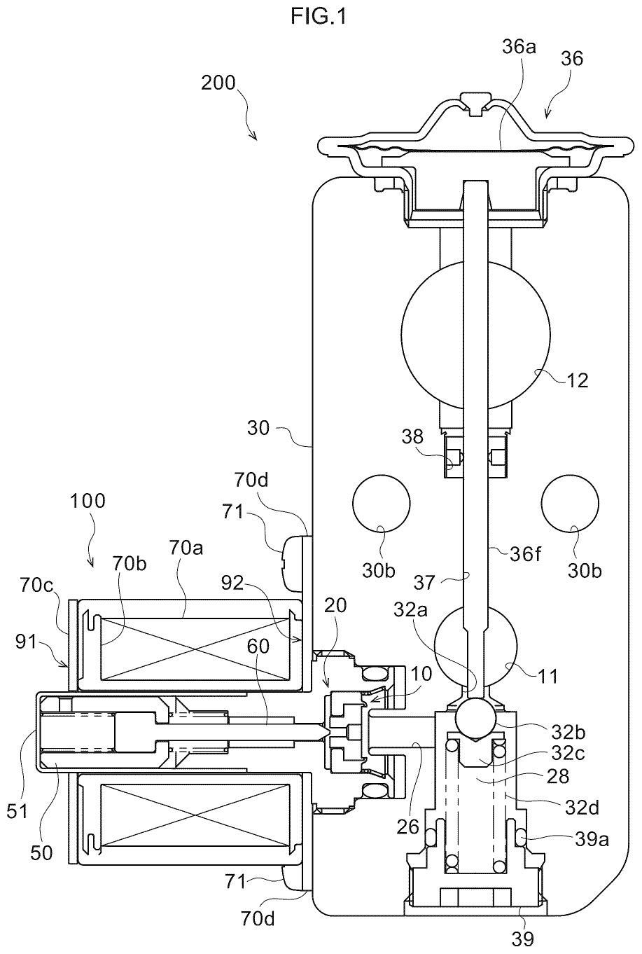

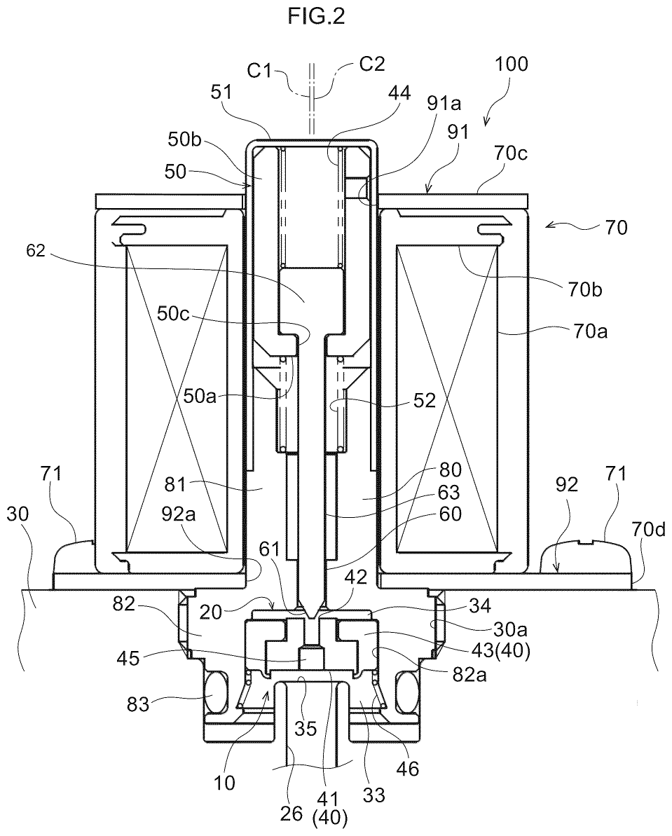

In FIGS. 1 and 2, an electromagnetic valve 100 according to the embodiment is used by being attached to, for example, an expansion valve 200 of a refrigeration cycle of an automobile air conditioner.

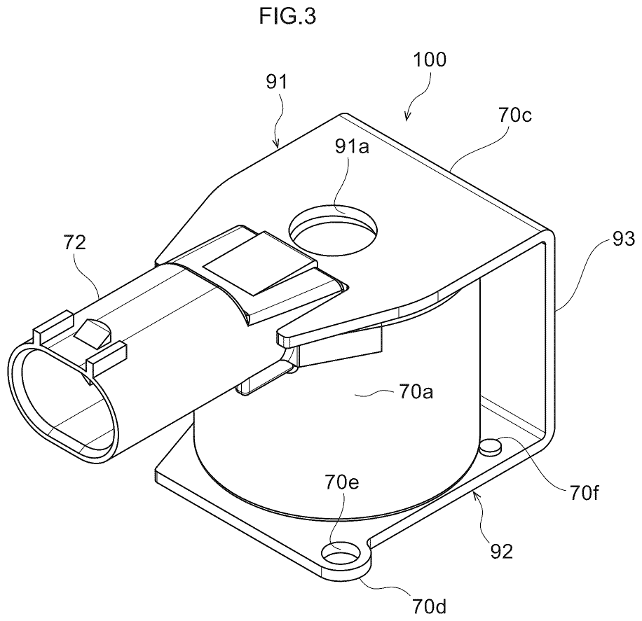

The electromagnetic valve 100 includes a solenoid 70, an attractor 80, a plunger 50, a pipe 51, and a housing 70c. The solenoid 70 is a member around which a coil 70a is wound and which generates magnetic force by energization. The coil 70a is provided with, for example, a joining terminal 72 (FIG. 3). The attractor 80 is a magnetic body disposed inside the solenoid 70, and is, for example, a moving core. The plunger 50 is a member that is connected to a valve shaft 60 as an example of a valve body and is attracted to the attractor 80 by energization of the solenoid 70. The pipe 51 is a bottomed member that is provided inside the solenoid 70 and accommodates the plunger 50.

In FIG. 2, the electromagnetic valve 100 opens and closes a main valve unit 10 to perform opening/closing control on flow of a fluid between an inlet (not shown) and an outlet 32 of the fluid in the expansion valve 200. The inlet and the outlet 32 are formed in a valve main body 30 as a valve body, and a main valve chamber 33 is provided between the inlet and the outlet 32. The main valve chamber 33 communicates with the inlet. In the main valve chamber 33, a main valve body 40 is accommodated to be slidable in an axial direction (an up-down direction in FIG. 2, hereinafter simply referred to as “up and down”) as will be described below. The valve main body 30 is made of, for example, a metal member such as aluminum, an aluminum alloy, or brass.

The main valve body 40 includes a main valve member 43 and main valve packing 41. The main valve member 43 is made of, for example, a metal material such as aluminum, stainless steel, or brass. The main valve body 40 is supported inside the main valve chamber 33 of the valve main body 30 to be slidable in the axial direction. The main valve unit 10 is disposed below the main valve body 40 in FIG. 2, that is, on one side in a sliding direction. The main valve unit 10 is formed by the main valve body 40 and a main valve seat 35 formed between the inlet and the outlet 32 of the valve main body 30. In the embodiment, a packing portion that opens and closes the main valve seat 35 is provided on an undersurface of the main valve packing 41 of the main valve body 40.

A pilot valve unit 20 is formed on the other side (an upper side in a shown example) in the sliding direction of the main valve body 40. In the embodiment, a pilot valve seat 42 is provided on a top surface of the main valve packing 41. The pilot valve seat 42 is opened and closed by the pilot valve unit 20 formed at a distal end portion (a distal end portion on a side opposite to a head portion 62).

The embodiment may have a configuration in which, as long as the pilot valve seat 42 can be closed, there is no need to provide the pilot valve packing that is a portion at which the pilot valve seat 42 on the upper surface side in FIG. 2 is provided, and the pilot valve seat portion is formed directly on the main valve member 43, and the packing portion on an undersurface side is attached to the main valve member 43. It is needless to say that both the packing portion that opens and closes the main valve seat 35 on the undersurface side and a portion (the pilot valve packing) in which the pilot valve seat 42 on the upper surface side is provided may be attached to, as separate members, the main valve member 43.

A pilot passage 45 extending in the axial direction is formed at a central portion of the main valve body 40 in the up-down direction. The pilot valve seat 42 is provided at an upper end of the pilot passage 45 in FIG. 2.

A tubular main valve member 43 is fitted on an outer surface of the main valve packing 41. The pilot passage 45 is formed in the main valve packing 41. The main valve body 40 has a pressure equalization hole (not shown) which is a through-hole extending in the axial direction. The pressure equalization hole allows the main valve chamber 33 and the pilot valve chamber 34 to communicate with each other. The pressure equalization hole equalizes a pressure in the main valve chamber 33 and a pressure in the pilot valve chamber 34. As a result, the main valve body 40 can be easily opened and closed.

The pipe 51 that is open downward is disposed at an upper center of the electromagnetic valve 100. The pipe 51 is a tubular member having a ceiling portion and a side wall. An end portion of the side wall of the pipe 51 opposite to the ceiling portion is attached to the attractor 80. Specifically, a lower end of the pipe 51 in FIG. 2 is open, and can be fixed to the attractor 80 to be described below by appropriate means such as caulking or welding. The plunger 50 is accommodated inside the pipe 51.

The plunger 50 is a tubular member having a bottom portion 50a and a side wall 50b. The bottom portion 50a of the plunger 50 is positioned on the pilot valve seat 42 side. The bottom portion 50a has a through-hole 50c. The plunger 50 of the embodiment is made of, for example, stainless steel having magnetism. The material of the plunger is not limited to stainless steel, and may be a magnetic material. The plunger 50 is provided inside the pipe 51 to be slidable in the axial direction by an operation of the solenoid 70.

The pilot valve seat 42 is opened and closed by the valve shaft 60. The valve shaft 60 has the head portion 62 and a shaft portion 63. The pilot valve unit 20 is provided at a distal end portion of the shaft portion 63 (a distal end portion on a side opposite to the head portion 62). The head portion 62 of the valve shaft 60 is disposed inside the plunger 50. The head portion 62 is larger in diameter than the shaft portion 63 in a radial direction of the valve shaft 60. A diameter of the shaft portion 63 is slightly smaller than a diameter of the through-hole 50c of the plunger 50. Therefore, the shaft portion 63 projects from the bottom portion 50a toward the valve seat, outside the plunger 50, in a state of being inserted into the through-hole 50c of the plunger 50.

A spring 44 is provided between the ceiling portion of the pipe 51 and the head portion 62 of the valve shaft 60. The valve shaft 60 is pressed against the plunger 50 due to a restoring force of the spring 44 provided in the pipe 51, for example. Consequently, the plunger 50 slides up and down in the pipe 51, together with the valve shaft 60 by the operation of the solenoid 70.

As means for driving the plunger 50 by the operation of the solenoid 70, the attractor 80 is provided. The attractor 80 is, for example, a magnetic material, generates a magnetic field when the solenoid 70 is energized by appropriate control means (not shown), overcomes a restoring force of a spring 52, and attracts the plunger 50 made of a magnetic material downward.

The attractor 80 has a multi-step cylinder shape in which through-holes are formed up and down as a whole, and the pipe 51 is attached thereto. In this state, the attractor 80 is inserted into or screwed into an upper large-diameter hole portion 30a formed in the valve main body 30. Thereafter, a male screw 71 is inserted into a through-hole formed in a protrusion portion 70d of the solenoid 70 inserted into the outer circumference of the pipe 51, and is screwed into a female screw formed in the valve main body 30, whereby the attractor 80 is pushed to and fixed to the valve main body 30. The cylindrical shape of the attractor 80 schematically has an upper small-diameter portion 81 and a lower large-diameter portion 82. A lower open end of the pipe 51 is fixed to the small-diameter portion 81, and the large-diameter portion 82 is fixed to the valve main body 30 as described above. The plunger 50 is accommodated to be slidable up and down in the pipe 51 fixed to the small-diameter portion 81.

A cylindrical main valve body accommodating portion (space portion) 82a is formed inside the large-diameter portion 82 of the attractor 80. The main valve body 40 is accommodated to be slidable up and down in the main valve body accommodating portion 82a. The main valve body 40 is lifted upward in the main valve chamber 33 by a restoring force of a main valve body spring 46. The space is divided up and down by the main valve body 40, so that a lower portion of the space becomes the main valve chamber 33 and an upper portion thereof becomes the pilot valve chamber 34. A space between the large-diameter portion 82 of the attractor 80 and the valve main body 30 are sealed by an O-ring 83, as appropriate.

In the shown example, the small-diameter portion 81 and the large-diameter portion 82 of the attractor 80 are formed as one member to form a cylindrical member having an integrated structure with a step interposed therebetween. It is needless to say that, in some embodiments, the small-diameter portion 81 and the large-diameter portion 82 may be formed as separate members, and both may be fixed by appropriate means (not shown). In short, it is sufficient that the attractor 80 can attract and drive the plunger 50 by energizing the solenoid 70. In the embodiment, a member that attracts and drives the plunger 50 and accommodates the main valve body 40 in a vertically slidable manner is referred to as the attractor. Whether the attractor 80 is formed of one member or a plurality of members does not matter.

The solenoid 70 is fitted in the outer circumferential surface of the pipe 51. The solenoid 70 includes a coil 70a, a bobbin 70b, and the housing 70c. The coil 70a is wound around the bobbin 70b. The housing 70c is made of a magnetic material. The housing 70c surrounds the bobbin 70b. On the lower side in the drawing, that is, on the side of the valve main body 30 of the housing 70c, the protrusion portion 70d that protrudes outward from the coil 70a on the side opposite to the pipe 51 is formed.

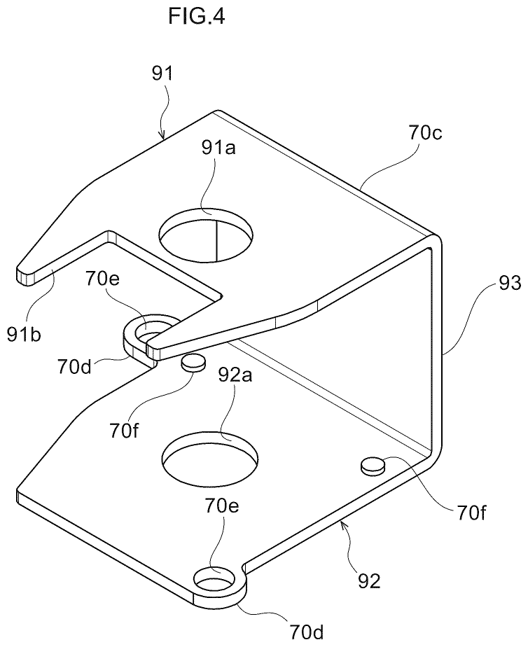

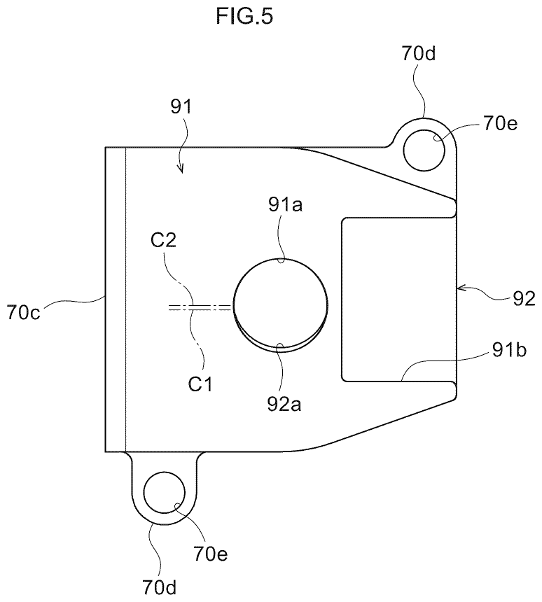

In FIGS. 2 to 5, the housing 70c includes a first support 91 disposed to overlap one end of the solenoid 70 in the axial direction and a second support 92 disposed to overlap the other end of the solenoid 70 in the axial direction, and surrounds the coil 70a. The housing 70c is formed in, for example, a U shape by the first support 91, the second support 92, and a connection portion 93 coupling the first support 91 and the second support 92.

A first attachment hole 91a and a second attachment hole 92a into which the pipe 51 is fitted are formed in the first support 91 and the second support 92, respectively. The first support 91 further has a notch 91b for curbing interference with the joining terminal 72. The second support 92 further has two protrusion portions 70d. Through-holes 70e are formed in the protrusion portions 70d, respectively. Male screws 71 (FIG. 2) are inserted into the through-holes 70e, respectively. The second support 92 has two protrusions 70f for positioning the coil 70a.

The first attachment hole 91a abuts the outer circumference of the pipe 51 on one side in the radial direction thereof. The second attachment hole 92a abuts the outer circumference of the pipe 51 on the other side in the radial direction thereof. As an example, the first attachment hole 91a and the second attachment hole 92a have circular shapes, for example, having the same diameter as each other, and a center C1 of the first attachment hole 91a and a center C2 of the second attachment hole 92a are shifted in the radial direction of the pipe 51. In FIG. 2, the center C1 of the first attachment hole 91a is shifted to a left side of the center C2 of the second attachment hole 92a. Consequently, an upper right-side outer circumference of the pipe 51 abuts the first attachment hole 91a, and a lower left-side outer circumference of the pipe 51 abuts the second attachment hole 92a. Which position of the pipe 51 in a circumferential direction thereof abuts the first attachment hole 91a and which position abuts on the second attachment hole 92a is determined by a relative positional relationship (shifting) between the first attachment hole 91a and the second attachment hole 92a.

In the above description, a state in which the second attachment hole 92a abuts the outer circumference of the pipe 51 on the other side in the radial direction includes a state in which the second attachment hole 92a abuts the attractor 80 as shown in FIG. 2. It is needless to say that the pipe 51 may extend downward to surround the outer circumferential portion of the attractor 80. In this case, the second attachment hole 92a abuts the pipe 51.

Since the second support 92 having the second attachment hole 92a is fixed to the valve main body 30 with the male screw 71 or the like, the first attachment hole 91a may abut the outer circumference of the pipe 51 on one side in the radial direction, and the second attachment hole 92a need not abut the outer circumference of the pipe 51 on the other side in the radial direction thereof.

Assuming that the first attachment hole 91a and the second attachment hole 92a have the same diameter, a shift length is from 3% to 9% of the hole diameter. When the shift length is shorter than this range, the pipe 51 is not sufficiently restrained by the housing 70c, and it becomes difficult to curb vibration. When the shift length exceeds this range, it becomes difficult to fit the pipe 51 into the first attachment hole 91a and the second attachment hole 92a.

### Expansion Valve

FIG. 1 shows a structure in which the electromagnetic valve 100 is attached to the expansion valve 200. The expansion valve 200 has a general structure, and thus will be briefly described. The expansion valve 200 includes the valve main body 30, a first passage 11 in which a refrigerant flows from a condenser or a receiver to an evaporator of a refrigeration cycle, and a second passage 12 in which a refrigerant flows from the evaporator to a compressor, and the first passage 11 and the second passage 12 are separated up and down from each other in the valve main body 30. The electromagnetic valve 100 is attached to be able to open and close a gap between the inlet and the outlet 32 in the first passage 11.

The expansion valve 200 further includes an orifice 32a and a valve chamber 28 provided in the first passage 11, a spherical valve body 32b disposed upstream of the outlet 32 which controls the amount of a refrigerant passing through the orifice 32a, and an adjustment screw 39 of a spring 32d which presses the valve body 32b toward the orifice 32a via a valve member 32c. An O-ring 39a is mounted on the adjustment screw 39 to secure an airtight state with the valve main body 30. An opening degree of the valve body 32b with respect to the orifice 32a is adjusted by the adjustment screw 39 and the pressing spring 32d.

The inlet of the first passage 11 communicates with the main valve unit 10, and communicates with the valve chamber 28 through a passage 26 when the electromagnetic valve 100 is opened. The valve main body 30 has bolt holes 30b formed to attach the expansion valve 200 to an installation place.

In the valve main body 30, in order to open and close the orifice 32a by applying a driving force to the valve body 32b depending on an outlet temperature of the evaporator, a hole 37 having a small diameter and a hole 38 having a diameter larger than that of the hole 37 are formed coaxially with the orifice 32a through the second passage 12. A power element unit 36 serving as a heat-sensitive unit is fixed to an upper end of the valve main body 30.

The power element unit 36 includes a temperature-sensitive rod 36f that slides in the large-diameter hole 38 and the small-diameter hole 37 to apply a driving force depending on the displacement of a diaphragm 36a. The top portion of the temperature-sensitive rod 36f abuts the undersurface of the diaphragm 36a, and the lower end of the temperature-sensitive rod 36f abuts the valve body 32b. The temperature-sensitive rod 36f is a valve body drive rod. The valve body drive rod may be formed by arranging a plurality of temperature-sensitive rods in series.

### Operations

The embodiment is configured as described above, and operations thereof will be described below. Here, a case in which the electromagnetic valve 100 is applied to the expansion valve 200 of the refrigeration cycle is described as an example. FIG. 2 shows a state in which the solenoid 70 (the coil 70a) is not energized. In this case, since no attractive force is generated in the attractor 80, the plunger 50 is lifted upward in the pipe 51 by the restoring force of the spring 52, and the pilot valve unit 20 is in an opened state. The main valve body 40 is lifted upward in the main valve chamber 33 by the restoring force of the main valve body spring 46, and the main valve unit 10 is in an open state.

When a compressor (not shown) is operated in this state, a refrigerant flows from the inlet (not shown) via the main valve unit 10 opened in the main valve chamber 33 through the outlet 32 (FIG. 1). Since the amount of a refrigerant flowing from the pilot valve chamber 34 to the main valve chamber 33 via the pilot passage 45 is larger than the amount of a refrigerant flowing from the main valve chamber 33 to the pilot valve chamber 34 via the pressure equalization hole (not shown), a pressure of the pilot valve chamber 34 becomes smaller than a pressure of the main valve chamber 33 so that a force applied upward is generated in the main valve body 40, and the main valve unit 10 is maintained in a sufficient-open state with the restoring force of the main valve body spring 46, and the flow from the inlet to the outlet 32 is maintained.

Next, when the solenoid 70 is energized, a magnetic field is generated, an electromagnetic attractive force is generated between the attractor 80 and the plunger 50, and the plunger 50 is pulled down against the restoring force of the spring 52. The valve shaft 60 slides up and down in the pipe 51 in the same manner as the plunger 50 moves. Hence, the plunger 50 is pulled down by the attractive force of the attractor 80, and the valve shaft 60 also slides downward by the restoring force of the spring 44. Consequently, the pilot valve unit 61 at the lower end of the valve shaft 60 abuts the pilot valve seat 42 formed on an upper side of the main valve body 40, and the pilot valve unit 20 is closed. That is, the pilot passage 45 is closed.

When the pilot passage 45 is closed, a passage communicating with the pilot valve chamber 34 and the main valve chamber 33 is only the pressure equalization hole (not shown), and a pressure difference between both valve chambers is eliminated. When the spring 44 further pushes down the main valve body 40 to slide to the lowermost point, the main valve body 40 abuts the main valve seat 35 to close the main valve unit 10. Consequently, the main valve unit 10 is also closed, a flow channel is closed, and the flow of the refrigerant or the like from the inlet to the outlet 32 is prevented.

When the energization of the solenoid 70 is stopped, the electromagnetic attractive force of the attractor 80 by the solenoid 70 is eliminated, the plunger 50 is pushed upward by the restoring force of the spring 52, the valve shaft 60 moves upward together with the plunger 50 against the restoring force of the spring 44, the pilot valve unit 61 of the valve shaft is separated from the pilot valve seat 42 provided on the upper surface side of the main valve body 40, and the pilot valve unit 20 is opened.

Consequently, the pilot valve chamber 34 communicates with the outlet 32 via the pilot passage 45 provided in a central portion of the main valve body 40, and the pressure in the pilot valve chamber 34 transitions from high pressure to low pressure.

Consequently, the main valve body 40 moves upward, and the main valve body 40 is separated from the main valve seat 35 and enters a valve open state. In addition to the operation of the electromagnetic valve 100, the flow of the refrigerant or the like is controlled by the expansion valve 200.

Here, in the electromagnetic valve 100 according to the embodiment, the housing 70c has both the first attachment hole 91a and the second attachment hole 92a into which the pipe 51 accommodating the plunger 50 is fitted. The first attachment hole 91a abuts the outer circumference of the pipe 51 on one side in the radial direction, and the second attachment hole 92a abuts the outer circumference of the pipe 51 on the other side in the radial direction thereof. That is, the pipe 51 is restrained by the housing 70c in the radial direction. Consequently, even if the plunger 50 is attached to or separated from the attractor 80 at high speed when the solenoid 70 is PWM-controlled, the vibration of the pipe 51 is curbed.

Since the centers C1 and C2 of the first attachment hole 91a and the second attachment hole 92a having the same diameter are shifted from each other in the radial direction of the pipe 51, the outer circumference of the pipe 51 on one side in the radial direction abuts the first attachment hole 91a, and the outer circumference of the pipe 51 on the other side in the radial direction abuts the second attachment hole 92a when the pipe 51 is fitted into the first attachment hole 91a and the second attachment hole 92a. Such a simple configuration enables vibration of the pipe 51 to be curbed.

Consequently, generation of noise and vibration in the electromagnetic valve 100 can be curbed. The opening and closing of the expansion valve 200 can be controlled by the electromagnetic valve 100. Hence, an improved electromagnetic valve is provided.

### Other Embodiments

Although one example of the embodiment of the disclosure has been described above, the embodiment of the disclosure is not limited to the above description, and it is needless to say that, in addition to the above-described example, various modifications can be made without departing from the gist of the disclosure.

The first attachment hole 91a and the second attachment hole 92a have circular shapes having the same diameter; however, the shape is not limited to the circular shape. The pipe 51 may be configured to be restrained by the housing 70c by alternately abutting inner circumferential portions of the first attachment hole 91a and the second attachment hole 92a. The ceiling portion of the pipe 51 may be formed of a separate member. That is, the pipe 51 may be configured by combining the cylindrical portion and the ceiling portion.

The entire disclosure of Japanese Patent Application No. 2023-7640 filed on Jan. 20, 2023 is incorporated herein by reference.

All of the literature, patent applications, and technical standards described in this specification are incorporated herein by reference to the same extent that individual literature, patent applications, and technical standards were specifically and individually described to be incorporated by reference.

1. An electromagnetic valve comprising:
a solenoid around which a coil is wound;
an attractor that is disposed inside the solenoid;
a plunger that is connected to a valve body and is attracted to the attractor by energization of the solenoid;
a pipe that is provided inside the solenoid and accommodates the plunger; and
a housing that includes a first support disposed to overlap with one end of the solenoid in an axial direction and a second support disposed to overlap with another end of the solenoid in the axial direction, and that has, in the first support and the second support, a first attachment hole and a second attachment hole into which the pipe is fitted, respectively, in which the first attachment hole abuts an outer circumference of the pipe on one side in a radial direction thereof.

2. The electromagnetic valve according to claim 1, wherein a center of the first attachment hole and a center of the second attachment hole are shifted in the radial direction of the pipe.

3. The electromagnetic valve according to claim 1, wherein the first attachment hole and the second attachment hole have a same diameter.

4. The electromagnetic valve according to claim 1, wherein:
the housing includes a plate-shaped connection portion that connects the first support and the second support, and
the first attachment hole abuts the outer circumference of the pipe on one side in a direction parallel to the connection portion.

5. The electromagnetic valve according to claim 1, wherein the second attachment hole abuts the outer circumference of the pipe on the other side in the radial direction thereof.
